(19) United States
(12) Patent Application Publication
(10) Pub. No.: US 2004/0220901 A1
(43) Pub. Date: Nov. 4, 2004

(54) System and method for association itemset mining

(75) Inventor: Chang-Hung Lee, Yunlin (TW)

Correspondence Address: Richard P. Berg, Esq., c/o LADAS & PARRY, Suite 2100, 5670 Wilshire Boulevard, Los Angeles, CA, 90036-5679, US

(73) Assignee: BENQ CORPORATION

(21) Appl. No.: 10/829,309

(22) Filed: Apr. 20, 2004

(30) Foreign Application Priority Data
Apr. 30, 2003 (TW) 92110131

(51) Int. Cl. G06F 17/30

(52) U.S. Cl. 707/2

(57) ABSTRACT

A system for association itemset mining. The system includes a database, a storage device and an association analysis unit. Each weighted record comprises a time scale and a weighted value. All transaction records are partitioned according to the time scale, each comprising at least one item. The association analysis unit calculates multiple weighted minimum support values, generates multiple itemsets among the transaction data stored in the database, and calculates weighted frequency for each itemset. In addition, it is determined whether the weighted frequency for each itemset exceeds the weighted minimum support value to generate the resulting association itemset.

### BACKGROUND OF THE INVENTION

1. Field of the Invention

The present invention relates to data mining systems, and more particularly, to a method and system of time-constraint association itemset mining used in data mining systems.

2. Description of the Related Art

The discovery of association relationship among items in large databases has proven useful in selective marketing, decision analysis and business management. A popular area of applications is market basket analysis, which studies the buying behavior of customers by searching for sets of items frequently purchased either together or in sequence. Recently, association itemset mining has been applied to web browsing behavior and stock transaction analysis.

For a given support threshold, the object of association mining identifies all associations that have support greater than the corresponding minimum support (denoted as min_supp) threshold. Association itemset mining algorithms have worked in generating all frequent itemsets that satisfy min_supp value.

One of the limitations is the time-consuming generation of associated items using conventional association mining from a database containing millions of transactions. In spite of this limitation, it is often argued that the association mining process may produce thousands of association relationships, some of which are unrelated and many of which are already known. Associated items generated by complicated conventional mining techniques always produce poor contributions to knowledge advancement.

Hence, several applications have referred to as for the use of constrained data mining. Specifically, in constraint-based mining, performed under the guidance of various constraints provided by the operator. The constraints addressed in the prior work include knowledge constraints, data constraints, interestingness constraints, and rule constraints. Such constraints may be expressed as meta-rules (rule templates), as the maximum or minimum number of predicates that can occur in the rule antecedent or consequent, or as relationships among attributes, attribute values, and/or aggregates.

Although the constraint-based mining described above allows specification of the rules to be mined according to particular needs, thereby leading to more useful mining results, several problems remain. Most of the databases are time-variant databases, consisting of values or events varying with time. The constraint-based association rule mining is unable to efficiently handle the time-variant database due to problems such as lack of consideration of the exhibition period of each individual transaction and lack of an intelligent support calculation basis for each item. Note that the conventional mining process treats transactions in different time periods indifferently and handles them along the same procedure. Thus, being unable to discover important association items and thoroughly remove unnecessary association items.

For example, a popular itemset of A milk and B bread may be frequently purchased together, but if A milk stopped selling because of recent competition issues, the association A milk and B bread is no longer useful, despite being generated by conventional association mining techniques among one-year transactions. In addition, C milk may have been active recently, individually as well as in association with D bread. C milk and D bread thus constitute a significant association for selective market decision making, but cannot be generated using the conventional association mining technique among one-year transactions using min_supp value.

In view of these limitations, a need exists for a system and method of association mining that considers the exhibition period of each individual transaction and provides an intelligent support calculation basis for each item, reducing process time and improving usability of results.

### SUMMARY OF THE INVENTION

It is therefore an object of the present invention to provide a system and method of mining the association relationship to reduce process time and improve usability usability of results. To achieve the above object, the present invention provides a system and method of association itemset mining that considers the exhibition period of each individual transaction and provides an intelligent support calculation basis for each item.

According to the invention, the system includes a database, a storage device, and an association analysis unit. The database stores a transaction record and a weighted record, and the storage device stores a minimal support (denoted as min_supp) value. Each weighted record comprises a time scale and a weighted value. All transaction records are partitioned according to the time scale, each comprising at least one item.

The association analysis unit first calculates multiple weighted min_supp values using a weighted min_supp equation whose parameters comprise the time scale, the weighted value and the min_supp value. Multiple itemsets are then generated among the items and weighted frequency is calculated for each itemset using a weighted frequency equation whose parameters comprise the weighted value. Finally, it is determined whether the weighted frequency for each itemset exceeds the weighted min_supp value. The association analysis unit generates itemsets for subsequent partitions, adding previously generated itemsets for the requisite partition, such that generations for each successive partition are incremental.

### BRIEF DESCRIPTION OF THE DRAWINGS

The present invention can be more fully understood by reading the subsequent detailed description and examples with references made to the accompanying drawings, wherein:

FIG. 1 is a diagram of the architecture of a system of association mining according to the invention;

FIG. 2 is a diagram of an exemplary weighted record according to the present invention;

FIG. 3 is a diagram of an exemplary transaction record according to the present invention;

FIG. 4 is a diagram of exemplary P₁ partition transactions according to the present invention;

FIG. 5 is a diagram of exemplary P₂ partition transactions according to the present invention;

FIG. 6 is a flowchart showing a method of association mining according to the invention;

FIG. 7 is a diagram of a storage medium for storing a computer program providing the method of the association mining according to the invention.

### DETAILED DESCRIPTION OF THE INVENTION

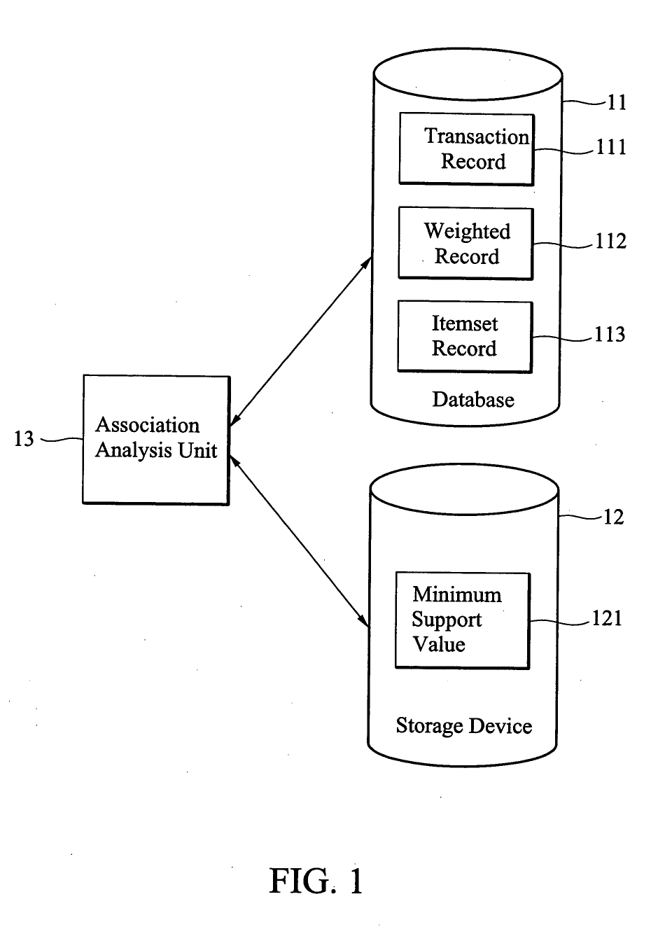

FIG. 1 is a diagram of the architecture of a system of association mining according to the invention. The system includes a database 11, a storage device 12, and an association analysis unit 13. The database stores multiple transaction records 111, weighted records 112 and itemset records 113, and the storage device 12 stores a minimum support (denoted as min₁₃ supp).

The database 11 can be implemented in a relational database or an object database. Contrary to the conventional transaction records, the transaction records 111 are partitioned according to the definition of time scale with each weighted record 112 belonging to a partition. Thus, the partition identity field is used to identify each transaction record 111 and weighted record 112. The implementation of both transaction records 111 and weighted records 112 described above is not limited to a single table, but also to multiple related tables. A transaction record 111 preferably comprises three fields, partition identity, transaction identity, and items, the transaction identity field being a primary key used to identify the record, the items field storing at least one transaction object. The weighted record 112 stores the information of time scale and the weighted value corresponding to each partition, preferably comprising partition identity, time scale, and weight fields. The itemset records 113 store the results of the association mining, both temporary and final, preferably comprising itemset, initiated partition, and correlation value fields. Consistent with the scope and spirit of the invention, additional or different fields may be provided.

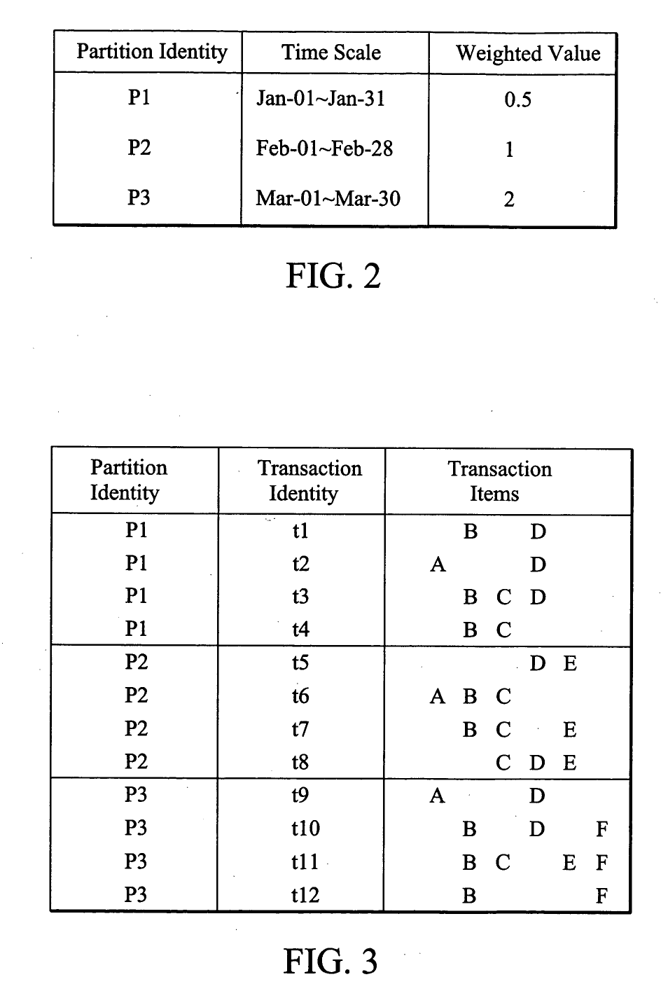

FIG. 2 is a diagram of an exemplary weighted record according to the invention. The weighted record 112 contains three records, the partition ranging from P1 to P3, representing January to March, and weights of 0.5, 1 and 2 respectively.

FIG. 3 is a diagram of an exemplary transaction record according to the invention. The transaction record 111 contains twelve records, ranging from t1 to t12, comprising partitions with transactions of t1 to t4, t5 to t8 and t9 to t12 respectively, each transaction having at least two items together forming an itemset. For example, the transaction of t1 indicates association of B and D.

The storage device 12 can be implemented in a database system, a file, or reside in a constant of program code storing a min_supp. In the embodiment, the minimum support is assumed to be min_supp=30%.

The association analysis unit 13 can be implemented in a database system, data warehouse system, data mining system or other data processing system. The association analysis unit 13 employs a progressive filtering scheme in each partition to deal with the candidate itemset generation and process one partition at a time. Specifically, a progressive candidate set of itemsets is composed of two types of candidate itemset, candidate itemsets carried over from the previous progressive candidate set in the previous phase, remaining as candidate itemsets after the current partition is included into consideration, referred to as type a candidate itemsets, and candidate itemsets not originally in the progressive candidate set in the previous phase but newly identified after taking only the current data partition into account, referred to as type β candidate itemsets. Under the invention, the cumulative information in the prior phases is selectively carried over toward the generation of candidate itemsets in the subsequent phases.

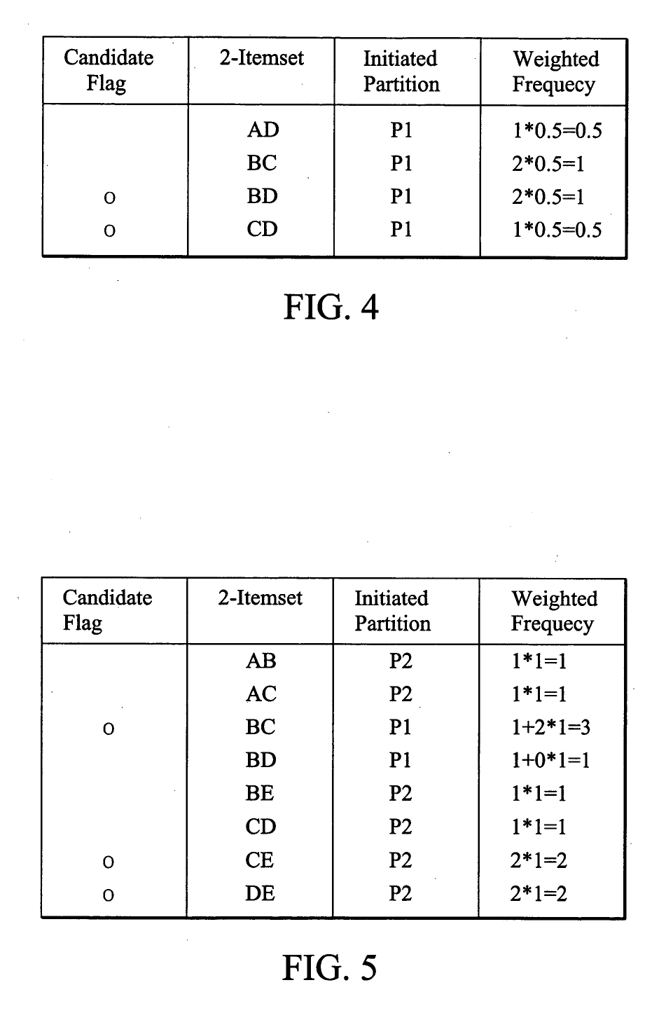

FIG. 4 is a diagram of exemplary P₁ partition transactions according to the invention. In phase 1, the association analysis unit 13 reads 4 transactions of the partition P1 as shown in FIG. 3, subsequently generates 2-itemsets {AD,BC,BD,CD} as shown in FIG. 4, calculates the frequency of each 2-itemset and records initiated partitions to P1. The association analysis unit 13 subsequent reads the weighted value of the partition P1 from the weighted record 112, as shown in FIG. 2, and calculates weighted frequency (denoted as X₂.count) for each 2-itemset. Equation (1) shows the formula for calculating weighted frequency of 2-itemset.

Equation (1):

X₂.count(P1)=N_{P1}(X₂)*W(P1),

where X₂.count(P1) is the weighted frequency of the 2-itemset in P1, N_{P1}(X₂) is the occurrence of the X₂ in P1 and W(P1) is the weighted value of P1. The weighted frequencies of each X₂, 0.5, 1, 1 and 0.5, are calculated thereby.

The association analysis unit 13 reads min_supp value 121 from the storage device 12 to calculate weighted min_supp value of P1. Equation (2) shows the formula for calculating weighted min_supp value of P1.

Equation (2):

min₁₃ supp(P1)=min_supp*N(P1)*W(P1),

where min_supp(P1) is the weighted min_supp value of P1, N(P1) is the sum of transactions in P1 and W(P1) is the weighted value of P1. Since there are four transactions in P1, the weighted min_supp value is min_supp(P1)=0.3*4*0.5=0.6. Such a weighted minimum support is referred to as the filtering threshold. Itemsets with weighted frequencies less than the filtering threshold are removed. Thus, as shown in FIG. 4, only {BC,CD}, marked by “O”, remain as candidate itemsets (of type β in this phase since they are newly generated) whose information is recorded to itemset record 113 and then carried over to the next phase P2 for subsequent process.

FIG. 5 is a diagram of exemplary P₂ partition transactions according to the invention. In phase 2, the association analysis unit 13 reads itemset record 113 to retrieve 2-itemsets {BC,BD} as type a candidate itemsets. After that, it subsequently scans partition P2 as shown in FIG. 2, generates 2-itemsets {AB,AC,BE,CD,CE,DE} except type α candidate itemsets, and records the initiated partitions P2. Weighted frequency of both type α and type β candidate itemsets is calculated using different formula according to the initiate partition.

Equation (3) shows the formula for calculating weighted frequency of 2-itemset when the initiate partition is P1.

Equation (3):

X₂.count(P1&P2)=X₂.count(P1)+N_{P2}(X₂)*W(P2),

where X₂.count(p1&P2) is the weighted frequency of the 2-itemset in P1 and P2, X₂.count(P1) is the weighted frequency of the 2-itemset in P1, N_{P2}(X₂) is the occurrence of the X₂ in P2 and W(P2) is the weighted value of P2. The weighted frequencies of each type α candidate itemset, 3 and 1, are calculated thereby.

Equation (4) shows the formula for calculating weighted frequency of 2-itemset when the initiate partition is P2.

Equation (4):

X₂.count(P2)=N_{P2}(X₂)*W(P2),

where X₂.count(P2) is the weighted frequency of the 2-itemset in P2, N_{P2}(X₂) is the occurrence of the X₂ in P2 and W(P2) is the weighted value of P2. The weighted frequencies of each type β candidate itemset are calculated thereby (4) as shown in FIG. 5.

The association analysis unit 13 reads min_supp value 121 from the storage device 12 to respectively calculate weighted min_supp value of P1&P2 and P2. Equation (5) shows the formula for calculating weighted min_supp value of P1&P2. Equation (6) shows the formula for calculating weighted min_supp value of P2.

Equation (5):

min_supp(P1&P2)=min₁₃ supp(P1)+min_supp*N(P2)*W(P2),

where min_supp(P1&P2) is the weighted min_supp value of P1&P2, min_supp(P1) is the weighted min₁₃ supp value of P1, N(P2) is the sum of transactions in P2 and W(P2) is the weighted value of P2.

Equation (6):

min_supp(P2)=min_supp*N(P2)*W(P2),

where min_supp(P2) is the weighted min₁₃ supp value of P2, N(P2) is the sum of transactions in P2 and W(P2) is the weighted value of P2.

The filtering threshold of itemsets carried over from the previous phase is min_supp(P1&P2)=0.6+4*0.3*1=1.8 and that of newly identified candidate itemsets is min_supp(P2)=4*0.3*1=1.2.

Itemsets with weighted frequencies less than the filtering threshold are removed. Thus, as shown in FIG. 5, only {BC,CE,DE}, marked by “O”, remain as candidate itemsets, wherein one is of α type and two β type, whose information is recorded to itemset record 113 and then carried over to the next phase P2 for subsequent process.

Although 2-itemset is used in the embodiment, the present invention is also can be applied to 3-itemset, 4-itemset, or k-itemset, where k is an integer.

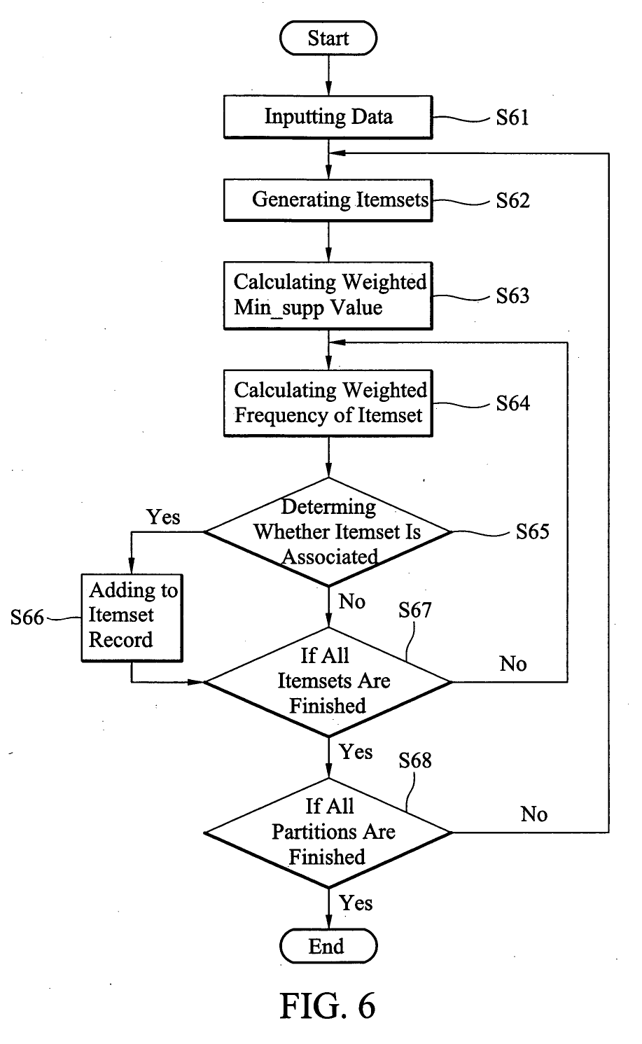

FIG. 6 is a flowchart showing a method of the association mining according to the invention.

The association analysis unit 13, first, in step S61, inputs the transaction record 111 in the partition P2 as shown in FIG. 3, weighted record 112 as shown in FIG. 4 and itemset record 113 from the database 11, and inputs the min_supp value 121 from the storage device 12.

Then, in step S62, 2-itemsets are acquired as candidate itemsets from the transaction record 111 and the itemset record 113. Type α candidate itemsets {BC,BD} are read from the itemset record 113 whose initiated partitions are P1. Type β candidate itemsets {AB,AC,BE,CD,CE,DE} are generated from the transaction record 111 whose initiated partitions are P2.

In step S63, the weighted minimum support of each associated partition is calculated. The weighted minimum support of P1&P2 and P2 is calculated thereby (5) and (6) respectively when the partition P2 is in process. In addition, when the partition P3 is in process, the weighted minimum support of P3, P2&P3 and P1&P2&P3 must be calculated.

In step S64, weighted frequency of a candidate itemset generated in step S62 is calculated. Different calculation formulas are used to calculate the weighted frequency according to the type of candidate itemset. Equations (3) and (4) are used to calculate type β and type a candidate itemsets respectively.

In step S65, it is determined whether the weighted frequency exceeds the corresponding filtering threshold. In step S66, candidate itemset with weighted frequency exceeding the corresponding filtering threshold are inserted into the result.

In step S67, it is determined whether any candidate itemset of the current partition remain unprocessed. If so, the process goes to step S63 to continually read next candidate itemset, otherwise, the process goes to step S68.

In step S68, it is determined whether any partitions remain unprocessed, if so, the process goes to step S61 to continually read next partition, otherwise, the process is complete.

The system and method of association mining of the present invention considers the exhibition period of each individual transaction and provides an intelligent support calculation basis for each item, reducing process time and improving usability of results.

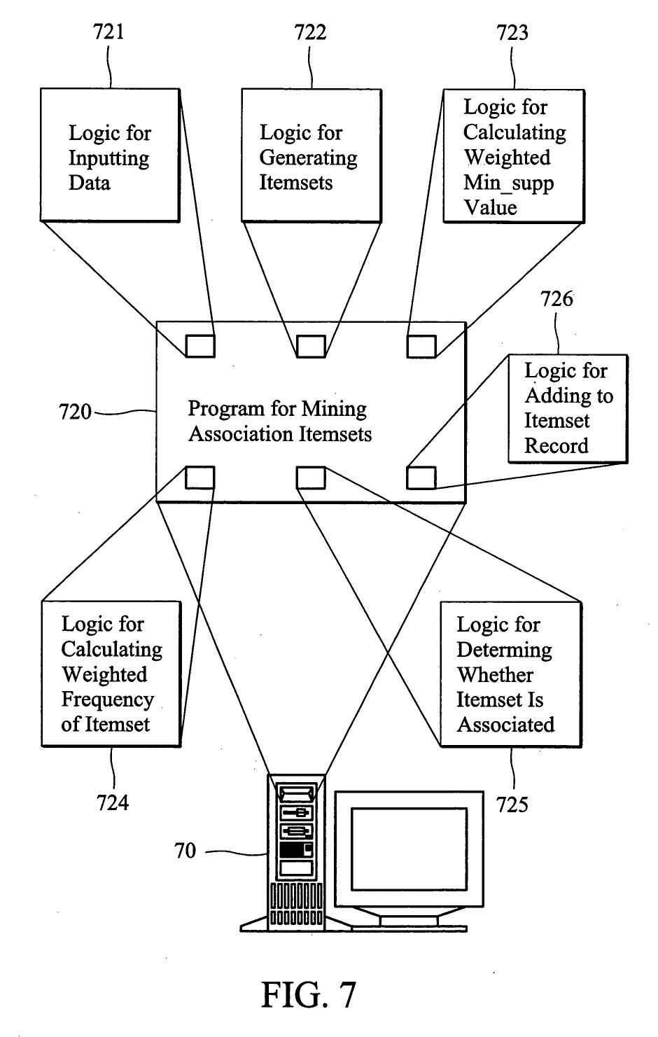

The methods and system of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits. The storage medium is shown in FIG. 7.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A system of mining association itemsets, comprising:
a database capable of storing at lease one weighted record and at least one transaction record, each weighted record comprising a time scale and a weighted value, the transaction records partitioned according to the time scale, and each transaction record comprising a plurality of items;
a storage device storing a minimum support value; and
an association analysis unit, configured to input the minimum support value, the transaction record and the weighted record, calculate at least one weighted minimum support value using a weighted minimum support equation whose parameters comprise the time scale, the weighted value and the minimum support value, and generate at least one itemset among the items, calculate a weighted frequency for each itemset using a weighted frequency equation whose parameters comprise the weighted value, determine whether the weighted frequency for each itemset exceeds the weighted minimum support value.

2. The system as claimed in claim 1 wherein an itemset record within the database comprises at least one itemset.

3. The system as claimed in claim 2 wherein the association analysis unit further adds the itemset with weighted frequency exceeding the weighted minimum support value.

4. The system as claimed in claim 1 wherein the weighted minimum support values for subsequent partitions are calculated by adding previously calculated weighted minimum support values to the result of the weighted minimum support equation for the requisite partition, such that calculations for each successive partition are incremental.

5. The system as claimed in claim 4 wherein the weighted minimum support equation is the minimum support value multiplied by the weighted value corresponding to the current partition plus the result of the weighted minimum support equation for the requisite partition.

6. The system as claimed in claim 4 wherein the weighted frequency of the itemset for subsequent partitions is calculated by adding previously calculated weighted frequencies to the result of the weighted frequency equation for the requisite partition, such that calculations for each successive partition are incremental.

7. The system as claimed in claim 6 wherein the weighted frequency equation comprises occurrence of the itemset in the current partition multiplied by the weighted value corresponding to the current partition plus the result of the weighted frequency equation for the requisite partition.

8. A method of mining association itemsets, the method comprising using a computer to perform the steps of:
inputting a time scale, a weighted value, at least one transaction record corresponding to the time scale, and a minimum support value, wherein the transaction records are partitioned according to the time scale and the transaction record comprises at least one item;
generating at least one itemset among the transaction records;
calculating at least one weighted minimum support value using a weighted minimum support equation whose parameters comprise the time scale, the weighted value and the minimum support value;
calculating a weighted frequency of each itemset using a weighted frequency equation whose parameters comprise the weighted value;
determining whether the weighted frequency of each itemset exceeds the weighted minimum support value.

9. The method as claimed in claim 8 further comprising a step of storing the itemset with weighted frequency exceeding the weighted minimum support value to an itemset record.

10. The method as claimed in claim 9 further comprising inputting the itemset generated for the prior partition from the itemset record.

11. The method as claimed in claim 8 wherein the weighted minimum support values for subsequent partitions are calculated by adding previously calculated weighted minimum support values to the result of the weighted minimum support equation for the requisite partition, such that calculations for each successive partition are incremental.

12. The method as claimed in claim 11 wherein the weighted minimum support equation is the minimum support value multiplied by the weighted value corresponding to the current partition plus the result of the weighted minimum support equation for the requisite partition.

13. The method as claimed in claim 11 wherein the weighted frequency of the itemset for subsequent partitions is calculated by adding previously calculated weighted frequencies to the result of the weighted frequency equation for the requisite partition, such that calculations for each successive partition are incremental.

14. The method as claimed in claim 13 wherein the weighted frequency equation comprises occurrence of the itemset in the current partition multiplied by the weighted value corresponding to the current partition plus the result of the weighted frequency equation for the requisite partition.

15. A storage medium for storing a computer program providing a method of mining association itemsets, the method comprising using a computer to perform the steps of:
inputting a time scale, a weighted value, at least one transaction record corresponding to the time scale and a minimum support value, wherein the transaction records are partitioned according to the time scale and the transaction record comprises at least one item;
generating at least one itemset among the transaction records;
calculating at least one weighted minimum support value using a weighted minimum support equation whose parameters comprise the time scale, the weighted value and the minimum support value;
calculating a weighted frequency of each itemset using a weighted frequency equation whose parameters comprise the weighted value;
determining whether the weighted frequency of each itemset exceeds the weighted minimum support value.

16. The method as claimed in claim 15 further comprising a step of storing the itemset with weighted frequency exceeding the weighted minimum support value to an itemset record.

17. The method as claimed in claim 16 further comprising inputting the itemset generated for the prior partition from the itemset record.

18. The method as claimed in claim 15 wherein the weighted minimum support values for subsequent partitions are calculated by adding previously calculated weighted minimum support values to the result of the weighted minimum support equation for the requisite partition, such that calculations for each successive partition are incremental.

19. The method as claimed in claim 18 wherein the weighted minimum support equation is the minimum support value multiplied by the weighted value corresponding to the current partition plus the result of the weighted minimum support equation for the requisite partition.

20. The method as claimed in claim 18 wherein the weighted frequency of the itemset for subsequent partitions is calculated by adding previously calculated weighted frequencies to the result of the weighted frequency equation for the requisite partition, such that calculations for each successive partition are incremental.

21. The method as claimed in claim 20 wherein the weighted frequency equation comprises occurrence of the itemset in the current partition multiplied by the weighted value corresponding to the current partition plus the result of the weighted frequency equation for the requisite partition.
